(19) United States
(12) Patent Application Publication
(10) Pub. No.: US 2020/0413334 A1
(43) Pub. Date: Dec. 31, 2020

(54) TRANSMIT OPTIMIZATIONS FOR INCREASED POWER SAVINGS ON LOW POWER NODES

(71) Applicant: QUALCOMM Incorporated, San Diego, CA (US)

(72) Inventors: Chirag Manojkumar Kharvar, Bangalore (IN); Jagdeep Kumar Hans, Bangalore (IN)

(21) Appl. No.: 16/455,424

(22) Filed: Jun. 27, 2019

(51) Int. Cl. H04W 52/02; H04W 76/14; H04L 1/18; H04W 40/00; H04W 88/04; H04W 76/28

(52) U.S. Cl. CPC H04W 52/0216; H04W 76/14; H04L 1/1867; H04W 12/0013; H04W 88/04; H04W 76/28; H04W 40/005

(57) ABSTRACT

A low power node (LPN) may identify one or more message repetition configurations (e.g., for one or more messages or payloads to be transmitted by the LPN, according to respective message repetition configurations) and may leverage a friend device for transmission operations associated with the message repetitions. For example, an LPN may indicate a payload (e.g., data or message information) and a corresponding message repetition configuration to a friend device (e.g., which may be wall powered and have access to more power resources), such that the friend device may perform transmission repetitions on behalf of the LPN. As such, upon conveying such payload and message repetition configuration information to the friend device, the LPN may enter a low power state (e.g., an idle mode, a sleep state, a discontinuous reception state, etc.) while the friend device performs transmission operations on behalf of the LPN (e.g., effectively conserving LPN power resources).

### BACKGROUND

The following relates generally to wireless communications, and more specifically to transmit optimizations for increased power savings on low power nodes (LPNs).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a device to communicate via the network (or communicate with other devices coupled to the access point). A device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more devices.

In some wireless communications system, devices that are capable of communicating directly (e.g., via Bluetooth) may form a mesh network to extend the range of communications. In a mesh network, content from one device may be delivered to another device via a relay system in which the content is forwarded by other mobile devices in the mesh network. In some cases, some devices (e.g., LPNs) may have limited resources (e.g., battery powered devices may be limited in terms of power consumption).

### SUMMARY

The described techniques relate to improved methods, systems, devices, or apparatuses that support transmit optimizations for increased power savings on low power nodes (LPNs). Generally, the described techniques provide for an LPN leveraging help of another mesh network device, such as a wall powered device (e.g., which may be referred to as a friend device), to offload some transmit operations (e.g., thus saving power resources at the LPN). For example, in some cases, an LPN may be configured (e.g., by the mesh network) to transmit a message according to some repetition pattern (e.g., an LPN may be configured with some message repetition configuration for a group transmission, for a unicast transmission, for periodic publishing, etc.). In some cases, the message repetition configuration (e.g., for a unicast transmission, a group transmission, periodic publishing, etc.) may configure a number of transmission repetitions for some message, where the number of transmission repetitions may be based on the application, noise or other channel conditions in the mesh network environment, the nature of the message payload, etc. As such, different LPNs may be associated with different message repetition configurations.

According to the described techniques, an LPN may identify one or more message repetition configurations (e.g., for one or more messages or payloads to be transmitted by the LPN, according to respective message repetition configurations) and may leverage a friend device for transmission operations associated with the message repetitions. For example, an LPN may indicate a payload (e.g., data or message information) and a corresponding message repetition configuration to a friend device (e.g., which may be wall powered and have access to more power resources), such that the friend device may perform transmission repetitions on behalf of the LPN. As such, upon conveying such payload and message repetition configuration information to the friend device, the LPN may enter a low power state (e.g., an idle mode, a sleep state, a discontinuous reception state, etc.) while the friend device performs transmission operations on behalf of the LPN (e.g., effectively conserving LPN power resources).

A method of wireless communications at a first device is described. The method may include identifying a message repetition configuration of the first device, and transmitting an indication of a number of transmission repetitions to a second device, where the number of transmission repetitions is based on the message repetition configuration of the first device. The method may further include receiving an acknowledgement from the second device based on the transmitted indication, and transmitting an information payload to the second device based on the received acknowledgement, where the first device is configured to transmit the information payload based on the message repetition configuration of the first device.

An apparatus for wireless communications at a first device is described. The apparatus may include a processor, memory in electronic communication with the processor, and instructions stored in the memory. The instructions may be executable by the processor to cause the apparatus to identify a message repetition configuration of the first device, transmit an indication of a number of transmission repetitions to a second device, where the number of transmission repetitions is based on the message repetition configuration of the first device, receive an acknowledgement from the second device based on the transmitted indication, and transmit an information payload to the second device based on the received acknowledgement, where the first device is configured to transmit the information payload based on the message repetition configuration of the first device.

Another apparatus for wireless communications at a first device is described. The apparatus may include means for identifying a message repetition configuration of the first device, transmitting an indication of a number of transmission repetitions to a second device, where the number of transmission repetitions is based on the message repetition configuration of the first device, receiving an acknowledgement from the second device based on the transmitted indication, and transmitting an information payload to the second device based on the received acknowledgement, where the first device is configured to transmit the information payload based on the message repetition configuration of the first device.

A non-transitory computer-readable medium storing code for wireless communications at a first device is described. The code may include instructions executable by a processor to identify a message repetition configuration of the first device, transmit an indication of a number of transmission repetitions to a second device, where the number of transmission repetitions is based on the message repetition configuration of the first device, receive an acknowledgement from the second device based on the transmitted indication, and transmit an information payload to the second device based on the received acknowledgement, where the first device is configured to transmit the information payload based on the message repetition configuration of the first device.

Some examples of the method, apparatuses, and non-transitory computer-readable medium described herein may further include operations, features, means, or instructions for transmitting a first message including the information payload, and entering a low power mode based on the transmitted first message. Some examples of the method, apparatuses, and non-transitory computer-readable medium described herein may further include operations, features, means, or instructions for transitioning from the low power mode to a high power mode, and determining a sequence number after the transitioning, where the sequence number may be calculated based on a transmission time of the transmitted first message, the number of transmission repetitions, a publish interval, or some combination thereof.

Some examples of the method, apparatuses, and non-transitory computer-readable medium described herein may further include operations, features, means, or instructions for starting a periodic publication timer based on the transmitted first message, where the sequence number may be determined based on the periodic publication timer, a publishing interval, and the transmission time of the transmitted first message. Some examples of the method, apparatuses, and non-transitory computer-readable medium described herein may further include operations, features, means, or instructions for transmitting the publishing interval with the information payload to the second device, where the information payload includes publishing information.

Some examples of the method, apparatuses, and non-transitory computer-readable medium described herein may further include operations, features, means, or instructions for transmitting, to the second device, an indication that the information payload corresponds to the number of transmission repetitions. Some examples of the method, apparatuses, and non-transitory computer-readable medium described herein may further include operations, features, means, or instructions for identifying a second message repetition configuration of the first device, transmitting a second indication of a second number of transmission repetitions to the second device, where the second number of transmission repetitions may be based on the second message repetition configuration of the first device, transmitting a second information payload to the second device, where the first device may be configured to transmit the second information payload based on the second message repetition configuration of the first device, and transmitting, to the second device, an indication that the second information payload corresponds to the second number of transmission repetitions.

Some examples of the method, apparatuses, and non-transitory computer-readable medium described herein may further include operations, features, means, or instructions for identifying a group publishing trigger, where the group publishing trigger includes a state change, a user event, or both, and transmitting a second message including a second information payload to the second device based on the identified group publishing trigger. Some examples of the method, apparatuses, and non-transitory computer-readable medium described herein may further include operations, features, means, or instructions for encrypting the indication of the number of transmission repetitions, where the indication of the number of transmission repetitions may be transmitted to the second device based on the encrypting, and encrypting the information payload, where the information payload may be transmitted to the second device based on the encrypting. In some examples of the method, apparatuses, and non-transitory computer-readable medium described herein, the indication of the number of transmission repetitions further includes a retry timeout for unsegmented messages.

A method of wireless communications at a second device is described. The method may include receiving an indication of a number of transmission repetitions from a first device, where the number of transmission repetitions is based on a message repetition configuration of the first device, and transmitting an acknowledgement to the first device based on the received indication. The method may further include receiving an information payload from the first device based on the transmitted acknowledgement, where the first device is configured to transmit the information payload based on the message repetition configuration of the first device, and transmitting a message including the information payload based on the indication of the number of transmission repetitions.

An apparatus for wireless communications at a second device is described. The apparatus may include a processor, memory in electronic communication with the processor, and instructions stored in the memory. The instructions may be executable by the processor to cause the apparatus to receive an indication of a number of transmission repetitions from a first device, where the number of transmission repetitions is based on a message repetition configuration of the first device, transmit an acknowledgement to the first device based on the received indication, receive an information payload from the first device based on the transmitted acknowledgement, where the first device is configured to transmit the information payload based on the message repetition configuration of the first device, and transmit a message including the information payload based on the indication of the number of transmission repetitions.

Another apparatus for wireless communications at a second device is described. The apparatus may include means for receiving an indication of a number of transmission repetitions from a first device, where the number of transmission repetitions is based on a message repetition configuration of the first device, transmitting an acknowledgement to the first device based on the received indication, receiving an information payload from the first device based on the transmitted acknowledgement, where the first device is configured to transmit the information payload based on the message repetition configuration of the first device, and transmitting a message including the information payload based on the indication of the number of transmission repetitions.

A non-transitory computer-readable medium storing code for wireless communications at a second device is described. The code may include instructions executable by a processor to receive an indication of a number of transmission repetitions from a first device, where the number of transmission repetitions is based on a message repetition configuration of the first device, transmit an acknowledgement to the first device based on the received indication, receive an information payload from the first device based on the transmitted acknowledgement, where the first device is configured to transmit the information payload based on the message repetition configuration of the first device, and transmit a message including the information payload based on the indication of the number of transmission repetitions.

Some examples of the method, apparatuses, and non-transitory computer-readable medium described herein may further include operations, features, means, or instructions for storing the message repetition configuration of the first device, where the message repetition configuration of the first device includes the information payload and the number of transmission repetitions. Some examples of the method, apparatuses, and non-transitory computer-readable medium described herein may further include operations, features, means, or instructions for receiving, from the first device, an indication that the information payload corresponds to the number of transmission repetitions, and identifying the message repetition configuration of the first device based on the received indication that the information payload corresponds to the number of transmission repetitions, where the message repetition configuration of the first device may be stored based on the identifying.

Some examples of the method, apparatuses, and non-transitory computer-readable medium described herein may further include operations, features, means, or instructions for identifying a busy status of the second device, and transmitting an indication of the busy status to the first device based on the received information payload. Some examples of the method, apparatuses, and non-transitory computer-readable medium described herein may further include operations, features, means, or instructions for receiving, from the first device, an indication that the information payload corresponds to the number of transmission repetitions. Some examples of the method, apparatuses, and non-transitory computer-readable medium described herein may further include operations, features, means, or instructions for identifying the first device may have transmitted a first message including the information payload, where the message including the information payload may be transmitted based on the identifying.

Some examples of the method, apparatuses, and non-transitory computer-readable medium described herein may further include operations, features, means, or instructions for receiving a second indication of a second number of transmission repetitions from the first device, where the second number of transmission repetitions may be based on a second message repetition configuration of the first device, receiving a second information payload from the first device, where the first device may be configured to transmit the second information payload based on the second message repetition configuration of the first device, receiving, from the first device, an indication that the second information payload corresponds to the second number of transmission repetitions, and transmitting a second message including the second information payload based on the second indication of the second number of transmission repetitions.

### BRIEF DESCRIPTION OF THE DRAWINGS

FIG. 1 illustrates an example of a system for wireless communications that supports transmit optimizations for increased power savings on low power nodes in accordance with aspects of the present disclosure.

FIG. 2 illustrates an example of a wireless communications system that supports transmit optimizations for increased power savings on low power nodes in accordance with aspects of the present disclosure.

FIG. 3 illustrates an example of a process flow that supports transmit optimizations for increased power savings on low power nodes in accordance with aspects of the present disclosure.

FIG. 4 illustrates an example of a process flow that supports transmit optimizations for increased power savings on low power nodes in accordance with aspects of the present disclosure.

FIGS. 5 and 6 show block diagrams of devices that support transmit optimizations for increased power savings on low power nodes in accordance with aspects of the present disclosure.

FIG. 7 shows a block diagram of a communications manager that supports transmit optimizations for increased power savings on low power nodes in accordance with aspects of the present disclosure.

FIG. 8 shows a diagram of a system including a device that supports transmit optimizations for increased power savings on low power nodes in accordance with aspects of the present disclosure.

FIGS. 9 through 14 show flowcharts illustrating methods that support transmit optimizations for increased power savings on low power nodes in accordance with aspects of the present disclosure.

### DETAILED DESCRIPTION

Some wireless communications systems (e.g., Bluetooth mesh networks) may include various combinations of devices that are wall powered (e.g., and have virtually unlimited power capacity) and devices that are battery powered (e.g., and are limited in power capacity). A battery powered device may be a device that operates using an internal, finite power source (e.g., as opposed to a device, such as a wall-powered device, that is powered by an external source, such as a power outlet). In some cases, such battery powered devices may be referred to as low power nodes (LPNs). Since the battery or power capacity of LPNs may be limited, LPNs may leverage other wall power devices (e.g., friend devices) to aid in performing some power consuming operations. That is, friend devices may include high capacity wall powered devices, and may assist LPNs (e.g., battery powered mobile devices) in performing tasks such that LPN power consumption may be reduced. For example, to optimize power consumption by an LPN some receiving operations, a friend device may cache packets on behalf of an LPN and allow the LPN to enter a low power mode (e.g., sleep state). As such, the LPN may save power in the low power mode while the friend device, with access to more power resources, caches packets directed to the LPN (e.g., the friend device may then deliver the cached packets to the LPN all at once when the LPN transitions back to a high power state, rather than the LPN remaining in a high power state to receive several packets over a period of time).

However, there may be opportunity for LPN power consumption optimization for transmit operations as well. For example, in some cases (e.g., for group transmissions, periodic publishing, etc.), LPNs may be configured to transmit information in a redundant (e.g., periodic) and/or repetitive (e.g., several transmission repetitions) manner. For instance, in cases where reliable messages and acknowledgements (ACKs) are not employed for group transmissions, a device (e.g., an LPN) may be configured to retry group message multiple times to ensure reliability of the message. Further, devices (e.g., LPNs) may be configured to periodically publish state information (e.g., capabilities information, application information, active/sleep state information, etc.) to let other subscribers (e.g., other devices of a mesh network) know in which state the device is operating in. Generally, an LPN may be configured with a message repetition configuration (e.g., with some number of repetitions or retries for a group or unicast message, with a periodicity for publishing state information, etc.).

According to the described techniques, for some transmission operations (e.g., some transmission activities, such as transmission repetitions), an LPN may leverage a friend device to reduce LPN power consumption. An LPN may inform a friend device regarding a message repetition configuration (e.g., the number of retries which are configured on the LPN device) for some message transmission, and may enable a transmit optimization feature. For example, an LPN may indicate a payload (e.g., data or message information) and a corresponding message repetition configuration to a friend device (e.g., which may be wall powered and have access to more power resources), such that the friend device may perform transmission repetitions on behalf of the LPN. As such, upon conveying such payload and message repetition configuration information to the friend device, the LPN may enter a low power state (e.g., an idle mode, a sleep state, a discontinuous reception state, etc.) while the friend device performs transmission operations on behalf of the LPN (e.g., effectively conserving LPN power resources).

Aspects of the disclosure are initially described in the context of a wireless communications system. Example process flows implementing the techniques discussed herein are then described. Aspects of the disclosure are further illustrated by and described with reference to apparatus diagrams, system diagrams, and flowcharts that relate to transmit optimizations for increased power savings on low power nodes

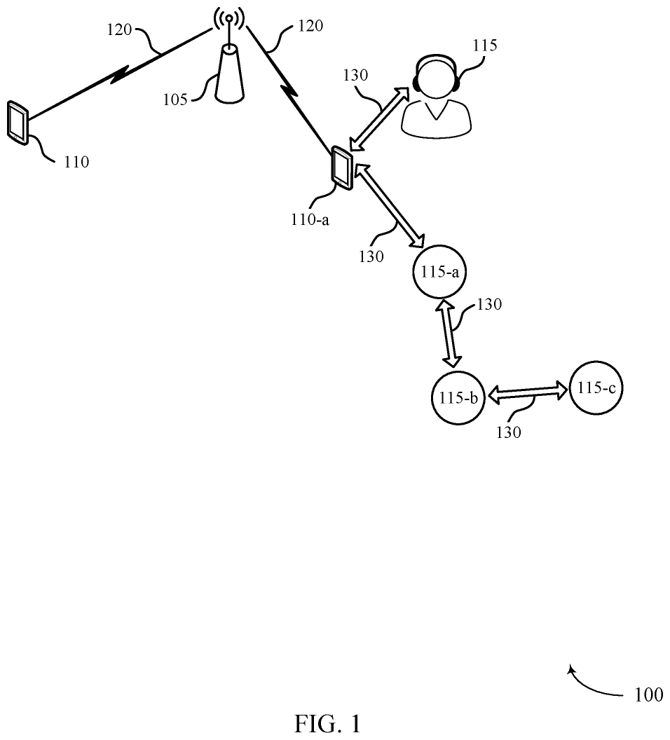

FIG. 1 illustrates a system 100 (e.g., which may include or refer to a wireless personal area network (PAN), a wireless local area network (WLAN), a Wi-Fi network) configured in accordance with various aspects of the present disclosure. The system 100 may include an AP 105, stations (STAs) 110, and wireless devices 115 implementing WLAN communications (e.g., Wi-Fi communications) and/or Bluetooth communications. For example, STAs 110 may include cell phones, mobile stations, personal digital assistant (PDAs), other handheld devices, netbooks, notebook computers, tablet computers, laptops, or some other suitable terminology.

Wireless devices 115 may include Bluetooth devices capable of pairing (e.g., independent of AP 105) with other Bluetooth devices (e.g., such as STAs 110), which may include wireless headsets, speakers, ear pieces, headphones, display devices (e.g., TVs, computer monitors), microphones, meters, valves, etc. Wireless devices 115 may be stationary (e.g., fixed in a particular location) or mobile (allowed to move about), and may be powered by external sources (e.g., a charging station) and/or internal sources. When a device is powered exclusively by internal or mobile power sources (e.g., one or more batteries or power-storage components), the devices may be referred to as battery-powered or power-limited devices. Thus, a battery-powered device may be disconnected from (e.g., isolated from) external or stationary power sources.

Bluetooth communications may refer to a short-range communication protocol and may be used to connect and exchange information between STAs 110 and wireless devices 115 (e.g., between mobile phones, computers, digital cameras, wireless headsets, speakers, keyboards, mice or other input peripherals, and similar devices). Bluetooth systems (e.g., aspects of system 100) may be organized using a master-slave relationship employing a time division duplex protocol having, for example, defined time slots of 625 mu secs, in which transmission alternates between the master device (e.g., a STA 110) and one or more slave devices (e.g., wireless devices 115). In some cases, a STA 110 may generally refer to a master device, and a wireless device 115 may refer to a slave device in a PAN. As such, in some cases, a device may be referred to as either a STA 110 or a wireless device 115 based on the Bluetooth role configuration of the device. That is, designation of a device as either a STA 110 or a wireless device 115 may not necessarily indicate a distinction in device capability, but rather may refer to or indicate roles held by the device in the PAN. Generally, STA 110 may refer to a wireless communication device capable of wirelessly exchanging data signals with an AP 105, and wireless device 115 may refer to a short-range wireless device capable of exchanging data signals with other devices (e.g., using Bluetooth communication protocols).

A Bluetooth device (e.g., a STA 110 or wireless device 115) may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth devices may be offering. The Bluetooth specification defines device role pairs that together form a single use case called a profile. One example profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device (e.g., STA 110-a) implements an audio source device (SRC) role and another device (e.g., wireless device 115-a) implements an audio sink device (SNK) role.

For a commercial Bluetooth device that implements one role in a profile to function properly, another device that implements the corresponding role must be present within the radio range of the first device. For example, in order for an HF device such as a Bluetooth headset to function according to the Handsfree Profile, a device implementing the AG role (e.g., a cell phone) must be present within radio range. Likewise, in order to stream high-quality mono or stereo audio according to the A2DP, a device implementing the SNK role (e.g., Bluetooth headphones or Bluetooth speakers) must be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement/repeat mechanisms, sequence numbering, scheduling behavior, etc.). The Bluetooth protocol stack is split in two parts: a “controller stack” containing the timing critical radio interface, and a “host stack” dealing with high level data. The controller stack is generally implemented in a low cost silicon device containing the Bluetooth radio and a microprocessor.

The controller stack may be responsible for setting up links 130 such as asynchronous connection-less (ACL) links, synchronous connection orientated (SCO) links, etc. Further, the controller stack may implement link management protocol (LMP) functions, low energy link layer (LE LL) functions, etc. The host stack is generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some cases, the controller stack and the host stack may communicate via a host controller interface (HCI). In other cases, (e.g., for integrated devices such as Bluetooth headsets), the host stack and controller stack may be run on the same microprocessor to reduce mass production costs. For such “hostless systems,” the HCI may be optional, and may be implemented as an internal software interface.

A link 130 established between two Bluetooth devices may provide for communications or services (e.g., according to some Bluetooth profile). For example, a Bluetooth connection may be an extended synchronous connection orientated (eSCO) link for voice call (e.g., which may allow for retransmission), an ACL link for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., wireless device 115-a) are acknowledged, and may be retransmitted if not acknowledged during a retransmission window. In addition, audio may be streamed between the STA 110-a and wireless device 115-a using an ACL link (A2DP profile). In some cases, the ACL link may occupy 1, 3, or 5 Bluetooth slots for data or voice. Other Bluetooth profiles supported by Bluetooth devices may include Bluetooth Low Energy (BLE) (e.g., providing considerably reduced power consumption and cost while maintaining a similar communication range), human interface device profile (HID) (e.g., providing low latency links with low power requirements), etc.

In some cases, a device may be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some cases, Bluetooth and WLAN communications may share a same medium, such as the same unlicensed frequency medium. In such cases, a STA 110 may support WLAN communications via AP 105 (e.g., over communication links 120). The AP 105 and the associated STAs 110 may represent a basic service set (BSS) or an extended service set (ESS). The various STAs 110 in the network may be able to communicate with one another through the AP 105. In some cases the AP 105 may be associated with a coverage area, which may represent a basic service area (BSA).

STAs 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within system 100. AP 105 may be coupled to a network, such as the Internet, and may enable a STA 110 to communicate via the network (or communicate with other STAs 110 coupled to the AP 105). A STA 110 may communicate with a network device bi-directionally. For example, in a WLAN, a STA 110 may communicate with an associated AP 105 via downlink (e.g., the communication link from the AP 105 to the STA 110) and uplink (e.g., the communication link from the STA 110 to the AP 105).

In some examples, content, media, audio, etc. exchanged between a STA 110 and a wireless device 115 may originate from a WLAN. For example, in some cases, STA 110-a may receive audio from an AP 105 (e.g., via WLAN communications), and the STA 110-a may then implement the described techniques to relay or pass the audio to the wireless device 115-a (e.g., via Bluetooth communications). In some cases, certain types of Bluetooth communications (e.g., such as high quality or high definition (HD) Bluetooth) may require enhanced quality of service. For example, in some cases, delay-sensitive Bluetooth traffic may have higher priority than WLAN traffic.

In some cases, the devices in system 100 may form a mesh network in which content is relayed from one device to another until it reaches the destination device. For example, wireless device 115-a may transmit content intended for wireless device 115-c to wireless device 115-b, which may forward the content to wireless device 115-c. Such a relay system, also referred to as directed forwarding, may extend the communication range of the wireless devices 115, which would otherwise be limited to communicating with paired device within signal range. The group of devices that form a relay may be referred to as a path.

In some cases, there may be multiple paths between the device with content (referred to as the “source” or “originator” device) and the device for which the content is intended (referred to as the “destination,” “termination,” or “target” device). When this happens, the decision-making device (e.g., the destination device or the source device) may select one of the paths to use.

According to the described techniques, for some transmission operations (e.g., some transmission activities, such as transmission repetitions), an LPN (e.g., wireless device 115-a) may leverage a friend device (e.g., wireless device 115-b) to reduce LPN power consumption. For example, wireless device 115-a may be a battery powered device, and may inform a wireless device 115-b (e.g., a friend device, which may be a wall powered device) regarding a message repetition configuration for some message transmission. In some cases, the wireless device 115-a may indicate a payload (e.g., data or message information) and a corresponding message repetition configuration (e.g., the number of retries which are configured on the LPN device for the data or message information) to wireless device 115-b. In some cases, the wireless device 115-b may then perform transmission repetitions on behalf of the wireless device 115-a (e.g., when the wireless device 115-b acknowledges the wireless device 115-a message repetition configuration or when the wireless device 115-b acknowledges the wireless device 115-a request for LPN transmit optimization feature). As such, upon conveying such payload and message repetition configuration information to the wireless device 115-b, the wireless device 115-a may enter a low power state (e.g., an idle mode, a sleep state, a discontinuous reception state, etc.) while the wireless device 115-b performs transmission operations on behalf of the wireless device 115-a (e.g., such that wireless device 115-a may effectively conserve power resources otherwise associated with the transmission operations passed to wireless device 115-b).

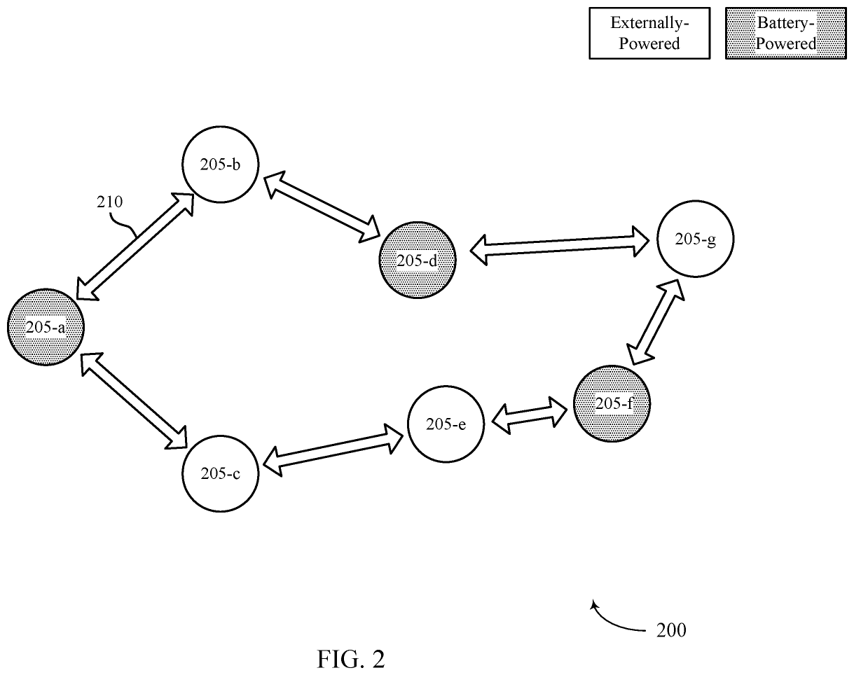

FIG. 2 illustrates an example of a wireless communications system 200 that supports transmit optimizations for increased power savings on low power nodes in accordance with aspects of the present disclosure. In some examples, wireless communications system 200 may implement aspects of system 100. Wireless communications system 200 may be an example of a mesh network (e.g., a Bluetooth mesh network or other type of mesh network). Wireless communications system 200 may include multiple devices 205, which may be devices that are capable of peer-to-peer communications (e.g., using Bluetooth or other short-range communication techniques). For example, the devices 205 may be examples of the wireless devices 115 described with reference to FIG. 1. The devices 205 may also be referred to as nodes, and each may represent a “hop” within the mesh network. The devices 205 may include a source device 205-a, a destination device 205-g, and intermediary devices 205-b through 205-f. An intermediary device may also be referred to as a relay device. The devices 205 may include externally-powered devices, shown in white, and battery-powered devices, shown in black.

In general, a mesh network (e.g., such as a mesh network exemplified by wireless communications system 200) may include combinations of devices 205 which are wall powered and have virtually unlimited power capacity (e.g., such as devices 205-b, 205-c, 205-e, and 205-g), and devices 205 which are battery powered and are limited in capacity (e.g., such as devices 205-a, 205-d, and 205-f). Since the capacity of battery powered devices may be limited, such batter powered devices may leverage some help by the other wall power devices. For this purpose, mesh networks may support Friend-LPN techniques. Where friend devices (e.g., such as devices 205-b, 205-c, 205-e, and 205-g) may include high capacity wall powered devices and LPN devices (e.g., such as devices 205-a, 205-d, and 205-f) may include battery powered mobile devices. These friend devices may help LPN devices operate in a low power or sleep state more frequently. For example, friend devices may cache packets on behalf of LPN devices (e.g., which help LPN devices to save power while operating in the lower power state).

In some cases, friend devices may help LPN devices save power by performing receive operations (e.g., packet caching, acknowledgement caching, etc.) on behalf of LPN devices. Further, friend devices may additionally help LPN devices save power by optimizations related to transmission operations. For example, some LPN transmission operations may lead to unnecessary power consumption (e.g., power waste) for redundant activities (e.g., such as configured LPN transmission repetitions). Two examples of such transmission operations may include group transmissions and periodic publishing.

In some cases, as reliable messages and acknowledgments may not be recommended (e.g., supported by a mesh network) for group transmissions, a device may retry a group message multiple times to provide reliability of the message. For example, any device (e.g., including LPNs) publishing/transmitting a message on a group may be configured (e.g., according to some message repetition configuration) to retry the message for a configured number of times (e.g., a number of transmission repetitions) to ensure reliability of a group message. Such mechanisms may be used for LPNs as well, where an LPN device publishing something on a group may be configured to retry the messages N times before sleeping again. Here the LPN device may end up unnecessarily consuming power for redundant transmissions. According to the techniques described herein, such LPNs may conserve power in such scenarios with the help of a friend device (e.g., which may have virtually unlimited source of power).

As another example, for periodic publishing, a device periodically publishes its state to let other subscribers know in which state the device is in. For example, periodic publishing may be a repetitive event, where a device (e.g., after each publish interval) publishes a message towards a group indicating the state or status in which the device is in. In some cases, since the publish message is directed towards a group, the LPN unnecessarily consuming power for redundant transmissions problem as described with reference to the group transmission discussion may also apply for such periodic publishing. For example, when an LPN publishes multiple messages (e.g., for different models), the LPN may keep on waking up to send the message, retry the message transmission some N number of times, and sleep again (e.g., and on the next publish interval it may wake up again and repeat the procedure). Consider a small publish period configured for LPN, the LPN (e.g., instead of saving battery) may end up consuming unnecessary power by performing repetitive tasks. Since LPN may associate with a friend device, which may have increased energy or power resources, the LPN may leverage the friend device's resources to perform such transmission operations (e.g., using the techniques described herein).

As discussed herein, for some transmission activities (e.g., transmission repetitions), LPN devices (e.g., devices 205-a, 205-d, and 205-f) may take help of a friend device (e.g., devices 205-b, 205-c, 205-e, and 205-g). For example, LPN device 205-a may inform a friend device (e.g., friend device 205-b) of a message repetition configuration (e.g., a number of retries which are configured on the LPN device 205-a for transmission of some payload). In some cases, the LPN device 205-a and the friend device 205-b may then enable a transmission optimization feature. As another example, LPN device 205-a may inform friend device 205-b of a publish interval and a start of periodic publishing. In such examples, LPN device 205-a may inform the friend device 205-b (e.g., the friend device which is doing periodic publishing on behalf of LPN device 205-a) of any change in the state of periodic publishing. The described techniques may be applied for various other examples of transmission operation offloading (e.g., from a LPN to a friend device) by analogy, without departing from the scope of the present disclosure.

To support such transmit optimizations for increased power savings on LPNs (e.g., LPN transmission repetition offloading to a friend device), an LPN may identify a message repetition configuration and transmit an indication of a number of transmission repetitions to a second device (e.g., where the number of transmission repetitions is based on the message repetition configuration). In some cases, the friend device may transmit an acknowledgement in response (e.g., which may enable such a transmission optimization feature). The LPN may then transmit an information payload to the friend device, and the friend device may perform transmission repetitions of the information payload (e.g., according to the number of transmission repetitions indicated by the LPN) on behalf of the LPN (e.g., such that the LPN may transition to a low power mode or sleep state, effectively conserving power resources).

Generally, a message repetition configuration may include any information pertaining to a transmission operation of an LPN (e.g., message repetition configuration information conveyed by an LPN to a friend device may include any information to enable the friend device to perform a transmission operation on behalf of the LPN). For example, a message repetition configuration may include payload information, a number of transmission repetitions, a publishing interval, a retry timeout for unsegmented messages, an acknowledgement caching command, an index of the message repetition configuration (e.g., in cases where the friend device may store multiple message repetition configuration associated with the LPN), etc. In some examples, an LPN may convey multiple message repetition configurations to a friend device (e.g., which may be stored by the friend device). In such cases, the LPN may indicate some index or identification (ID) corresponding to each of the message repetition configurations. As such, the LPN may subsequently be able to indicate a payload as well as a message repetition configuration index or message repetition configuration ID corresponding to the payload.

In some cases, LPN message repetition configuration (e.g., configured by a mesh network) may be based on the application, the noise or channel conditions of the mesh network environment, the nature of the payload, etc. (e.g., message repetition configurations may be different for different LPNs, different transmissions of an LPN, different mesh network conditions, etc.). For example, in mesh networks with high noise environments (e.g., or relatively poor channel conditions) a message repetition configuration may be associated with a relatively higher number of transmission repetitions than a message repetition configuration for an LPN in a low noise environment (e.g., as a higher number of transmission repetitions may increase the reliability of the message transmission). In another example, a message repetition configuration may depend on the application. For example, in the example of FIG. 2, LPN device 205-a may represent a light switch, and devices 205-b through 205-g may represent light sources (e.g., controllable by the LPN device 205-a). Such an example scenario may be associated with message repetition configurations with a higher number of transmission repetitions than, for example, a scenario with one light switch and one light source (e.g., as the latter scenario may be associated with increased probability of a successful transmission to all light sources, as there may be only one light source).

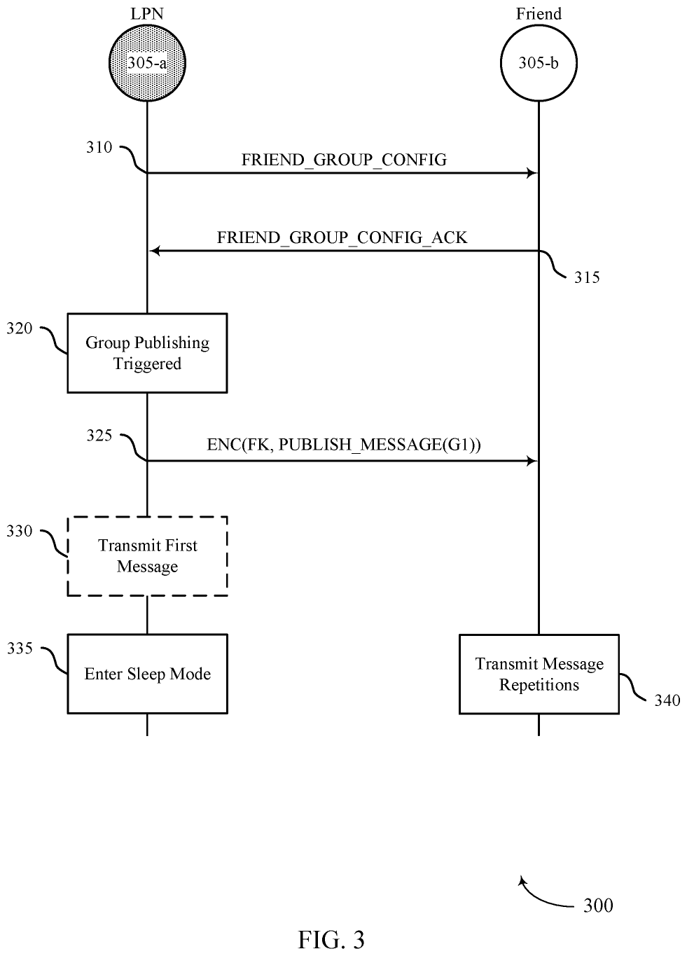

FIG. 3 illustrates an example of a process flow 300 that supports transmit optimizations for increased power savings on low power nodes in accordance with aspects of the present disclosure. In some examples, process flow 300 may implement aspects of system 100 and/or wireless communications system 200. Process flow 300 may be an example of a process flow that occurs within a mesh network (e.g., a Bluetooth mesh network or other type of mesh network). The process flow 300 may illustrate an LPN device 305-a configuring a friend device 305-b for transmission retries (e.g., for group transmission repetitions or unicast transmission repetitions). Aspects of process flow 300 may be implemented by one or more devices 305, which may be examples of the devices 205 described with reference to FIG. 2. In the following description of the process flow 300, the operations between the LPN device 305-a and the friend device 305-b may be transmitted in a different order than the exemplary order shown, or the operations performed by LPN device 305-a and friend device 305-b may be performed in different orders or at different times. In some cases, certain operations may also be left out of the process flow 300, or other operations may be added to the process flow 300. In some cases, some operations of the process flow 400 may be included in process flow 300 (e.g., or some operations of the process flow 400 may replace some operations of the process flow 300).

Various mechanisms may be used for an LPN device to communicate transmission optimization information to a friend device. For example, control messages exchanged between a friend device and an LPN device may convey information for LPN transmission optimizations (e.g., message repetition configuration information, acknowledgement information, payload update information, etc.). In some cases, such control messages may be encrypted (e.g., with friendship keys) and, in some cases, may have the same configuration as friend polling messages (e.g., FRIEND_POLL messages) and friend update messages (e.g., FRIEND_UPDATE messages). For example, in some cases, message repetition configuration information (e.g., an indication of the number of transmission repetitions) may be encrypted and/or any information payload (e.g., and corresponding message repetition configuration indication) may be encrypted.

At 310, LPN device 305-a may transmit message repetition configuration information to friend device 305-b. For example, in some cases, LPN device 305-a may identify a message repetition configuration (e.g., a message repetition configuration of the LPN device 305-a) and may transmit an indication of a number of transmission repetitions to friend device 305-b (e.g., where the number of transmission repetitions is based on the message repetition configuration of the LPN device 305-a). In some cases, the message repetition configuration information may be conveyed via a FRIEND_GROUP_CONFIG message to friend device 305-b (e.g., on Friend Key), and the FRIEND_GROUP_CONFIG message may include the information regarding a number of retries (e.g., for a group message, a unicast message, etc.).

In some cases, the FRIEND_GROUP_CONFIG message may include a retry timeout for unsegmented messages. For example, LPN device 305-a may indicate (e.g., to friend device 305-b via FRIEND_GROUP_CONFIG message) that a message payload has four segments, which are to be transmitted five times (e.g., according to some interval). In some cases, the LPN device 305-a may further indicate a time duration (e.g., a retry timeout for unsegmented messages) for which the friend device 305-b is to wait for acknowledgments (e.g., addressed to the LPN device 305-a) corresponding to the message payload. The friend device 305-b may receive and cache any acknowledgements for the LPN device 305-a (e.g., while the LPN device 305-a may be in a low power mode or sleep state). If only a portion of the expected acknowledgements are received (e.g., only a portion of the four segments are acknowledged by some other device(s) in the mesh network), the friend device 305-b may attempt to retransmit (e.g., according to the original number of repetitions) either the entire message payload or the unacknowledged segments of the message payload following expiration of the retry timeout for unsegmented messages.

At 315, friend device 305-b may (e.g., after receiving the FRIEND_GROUP_CONFIG message) store the message repetition configuration (e.g., or message repetition configuration information) for the LPN device 305-a, and the friend device 305-b may transmit an acknowledgement with success/failure to indicate the status of the configuration request (e.g., a FRIEND_GROUP_CONFIG_ACK message indicating an acceptance or denial of the request to enable an LPN transmission optimization feature).

In some cases, at 320, a state change or any other user event may trigger group publishing on the LPN device 305-a. For example, state change or any other user event may trigger implementation of LPN transmission optimization techniques described herein. Upon identification of such a trigger, the LPN device may proceed to 325 (e.g., upon identification of some trigger, the LPN device 305-a may transmit payload information to a friend device 305-b for the friend device to perform message repetition transmissions on behalf of the LPN device 305-a). In some cases (e.g., when a trigger identified at 320 occurs after 340), the LPN device 305-a may identify a group publishing trigger (e.g., where the group publishing trigger includes a state change of the LPN device 305-a, a user event, or both), and the LPN device 305-a may transmit a second message (e.g., a second FRIEND_GROUP_CONFIG message and/or a second ENC message) to the friend device 305-b (e.g., where the second message includes a second information payload based on the identified group publishing trigger).

At 325, the LPN device 305-a may transmit an information payload to the friend device 305-b based on the received acknowledgement (e.g., at 315) and/or the identified trigger (e.g., at 320). For example, LPN device 305-a may transmit an information payload (e.g., an information payload that the LPN device 305-a is configured, by the mesh network, to transmit based on the message repetition configuration of the LPN device 305-a) to the friend device 305-b. In some cases, the information payload (e.g., a group 1 (G1) publish message (PUBLISH MESSAGE) encrypted using a Friend Key, or an ENC(FK, PUBLISH MESSAGE(G1)) message) may be prepared by the LPN device 305-a sent over Friend Key (FK) so that only friend device 305-a may understand the message.

In some examples, at 330, the LPN device 305-a may transmit a first message (e.g., a first message of the configured message transmission repetitions). In other examples, the LPN device 305-a may not transmit any further messages (e.g., and all message transmissions may be left up to the friend device 305-b).

At 335, the LPN device 305-a may enter a low power mode or sleep state. For example, in some cases, the LPN device 305-a may transmit a first message comprising the information payload (e.g., at 330), and may enter a low power mode based on the transmitted first message (e.g., and the enabled transmission optimization feature, such that the friend device 305-b is to transmit the remaining message repetitions on behalf of the LPN device 305-a). In other examples, the LPN device 305-a may enter a low power mode based on the transmitted information payload (e.g., and the enabled transmission optimization feature, such that the friend device 305-b is to transmit all message repetitions on behalf of the LPN device 305-a).

At 340, the friend device 305-b may transmit message repetitions on behalf of the LPN device 305-a while the LPN device 305-a transitions to and operates in a low power mode. For example, the friend device 305-b may transmit repetitions of the information payload (e.g., received at 325) according to the message repetition configuration of the LPN device 305-a (e.g., where message repetition configuration information may be received from the LPN device 305-a at 310). For example, since the friend device 305-b may know that retries for group messages are configured, the friend device 305-b may take the publish message (e.g., received at 325) and transmits it with the current sequence (SEQ) number and the LPN device 305-a's unicast address (e.g., as the source (SRC) address in the message header). After this, for each retry, the friend device 305-b may increment the SEQ number. Once done, the friend device 305-b may update the SEQ number of LPN into its routing protocol for low power and lossy networks (RPL).

Further, in some examples, while the friend device 305-b is transmitting on behalf of LPN device 305-a, the LPN device 305-a may note down the timing of the message and may enter a low power mode or sleep state. Upon wake up (e.g., upon transitioning from the low power mode back to a high power mode), the LPN device 305-a may calculate SEQ number based on amount of retries configured and/or publish interval. For example, upon transitioning from the low power mode to a high power mode, the LPN device 305-a may determine a sequence number (e.g., SEQ number) after the transitioning, where the sequence number is calculated based on a transmission time of the transmitted first message (e.g., at 330), the number of transmission repetitions, a publish interval, etc. (e.g., indicated at 310). This way, LPN device 305-a may sleep after sending only one message for the group and may leave retries to friend device 305-b. In some cases, such may result in a significant amount of power savings for the LPN device 305-a (e.g., the power savings based on number of retries).

In some cases, an LPN device may indicate more than one message repetition configuration to a friend device (e.g., at 310). For example, as discussed herein, an LPN device may be configured with multiple message repetition configurations (e.g., a mesh network may configure an LPN with different message repetition configurations for periodic publishing operations, group message transmissions, different payload priorities, different applications, etc.). As such, in some cases, an LPN device may indicate multiple message repetition configuration to a friend device (e.g., and each message repetition configuration may be associated with some index or ID). In such cases, when an LPN device indicates an information payload to a friend device for transmission optimization features, the LPN device may further indicate a message repetition configuration corresponding to the information payload. For example, at 325, LPN device 305-a may include an indication that the information payload corresponds to one of the message repetition configurations (e.g., indicated at 310) stored at the friend device 305-b.

For example, in some cases, LPN device 305-a may identify a second message repetition configuration and transmit a second indication of a second number of transmission repetitions to the friend device 305-b (e.g., where the second number of transmission repetitions may be based on the second message repetition configuration). LPN device 305-a may transmit a second information payload to the friend device 305-b, where the LPN device 305-a may be configured to transmit the second information payload based on the second message repetition configuration. LPN device 305-a may then transmit, to the friend device 305-b, an indication that the second information payload corresponds to the second number of transmission repetitions.

Further, in some cases, upon entering a sleep state (e.g., at 335), LPN device 305-a may indicate a SEQ number associated with the information payload at 325. The LPN device 305-a may also track SEQ numbers while in the sleep state. For example, LPN device 305-a may indicate some SEQ number X with the information payload conveyed at 325, and may further indicate, for example, two as the number of transmission repetitions for the information payload. As such, the friend device 305-b may transmit the information payload with SEQ numbers X+1 and X+2. When the LPN device 305-a transitions from the low power mode to back to a high power mode, the LPN device 305-a may use X+3. For example, when LPN device 305-a indicates an information payload to friend device 305-b (e.g., at 325), the LPN device 305-a may start a timer (e.g., and may thus track SEQ numbers in the sleep state). In some examples, if the LPN device 305-a wakes up before X+2, the LPN device 305-a may, in some cases, disable the friend device 305-b from performing the transmission optimization features and may use X+2 itself (e.g., the LPN device 305-a may indicate the friend device 305-b may stop transmitting repetitions, and the LPN device 305-a may transmit the transmission repetitions itself).

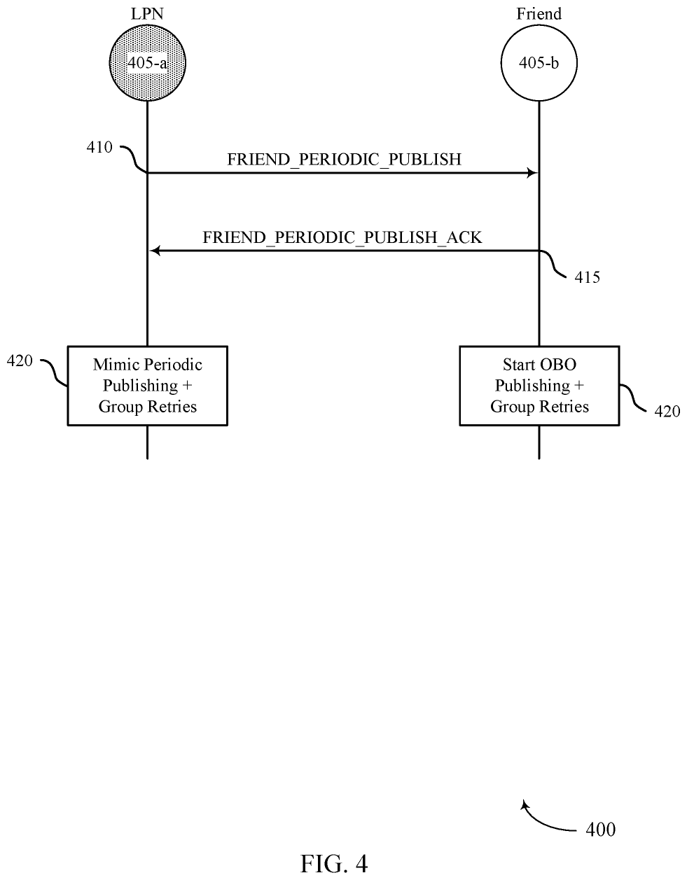

FIG. 4 illustrates an example of a process flow 400 that supports transmit optimizations for increased power savings on low power nodes in accordance with aspects of the present disclosure. In some examples, process flow 400 may implement aspects of system 100 and/or wireless communications system 200. Process flow 400 may be an example of a process flow that occurs within a mesh network (e.g., a Bluetooth mesh network or other type of mesh network). The process flow 400 may illustrate configuration of a friend device 405-b for performing aspects of periodic publishing on behalf of the LPN device 405-a. Aspects of process flow 400 may be implemented by one or more devices 405, which may be examples of the devices 205 described with reference to FIG. 2. In the following description of the process flow 400, the operations between the LPN device 405-a and the friend device 405-b may be transmitted in a different order than the exemplary order shown, or the operations performed by LPN device 405-a and friend device 405-b may be performed in different orders or at different times. In some cases, certain operations may also be left out of the process flow 400, or other operations may be added to the process flow 400. In some cases, some operations of the process flow 300 may be included in process flow 400 (e.g., or some operations of the process flow 300 may replace some operations of the process flow 400).

Various mechanisms may be used for an LPN device to communicate transmission optimization information to a friend device. For example, control messages exchanged between a friend device and an LPN device may convey information for LPN transmission optimizations (e.g., message repetition configuration information, acknowledgement information, payload update information, etc.).

For example, at 410, LPN device 405-a may want to start periodic publishing (e.g., this may be because of a config client setting publish interval to a non-zero value), and the LPN device 405-a may send a FRIEND_PERIODIC_PUBLISH message to friend device 405-b. The FRIEND_PERIODIC_PUBLISH message may include the payload to be published (e.g., an information payload) and a publish interval. This message may or may not include group retries (e.g., since it may already be covered using a FRIEND_GROUP_CONFIG message).

At 415, the friend device 405-b may transmit an acknowledgement message (e.g., a FRIEND_PERIODC_PUBLISH_ACK message) to the LPN device 405-a. In some cases, the acknowledgement message may acknowledge successful receipt of the FRIEND_PERIODIC_PUBLISH message, may enable the transmission optimization feature (e.g., may enable a feature where the friend device 405-b transmits message repetitions on behalf of the LPN device 405-a), etc.

At 420, both LPN device 405-a and friend device 405-b may start a periodic publish timer. However, only the friend device 405-b may transmit the message repetitions, and the LPN device 405-a may mimic the activity to maintain the integrity of SEQ numbers.

In some cases, any time a friend device is transmitting on behalf of an LPN, the friend device may reject the friend polls (e.g., FRIEND_PERIODIC_PUBLISH messages, FRIEND_PERIODIC_PUBLISH UPDATE messages, information payload indications, etc.) by sending FRIEND_UPDATE_BUSY message in response to FRIEND_POLL. If an LPN which has enabled TX optimization feature, gets FRIEND_UPDATE_BUSY message then the LPN may ignore that poll without terminating friendship (e.g., the LPN may transmit its own message repetitions for that information payload, and may continue to poll the friend for later transmit optimizations). In cases where the LPN is to inform a friend device, which is doing on behalf of publishing for LPN, regarding the state change, a new message called FRIEND_PERIODIC_PUBLISH UPDATE message may be sent by LPN to update the payload of the publish message. When a friend device receives this message, the friend device may replace the payload of the message with the current payload which it is transmitting periodically. For example, the friend device may use same message repetition configuration information received previously from the LPN, and the friend device may replace the information payload with the updated information payload and transmit repetitions of the information payload according to the message repetition configuration information. In some cases, the friend device may use the same message (e.g., FRIEND_PERIODIC_PUBLISH message) for stopping on behalf of periodic publishing. For example, in some cases such may be done by setting value of publish interval in the message to 0.

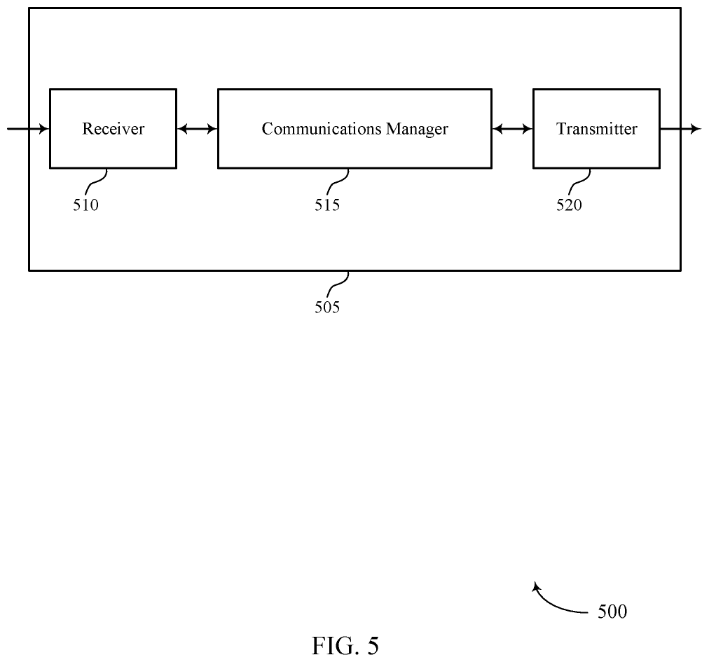

FIG. 5 shows a block diagram 500 of a device 505 that supports transmit optimizations for increased power savings on low power nodes in accordance with aspects of the present disclosure. The device 505 may be an example of aspects of a device as described herein. The device 505 may include a receiver 510, a communications manager 515, and a transmitter 520. The device 505 may also include a processor. Each of these components may be in communication with one another (e.g., via one or more buses).

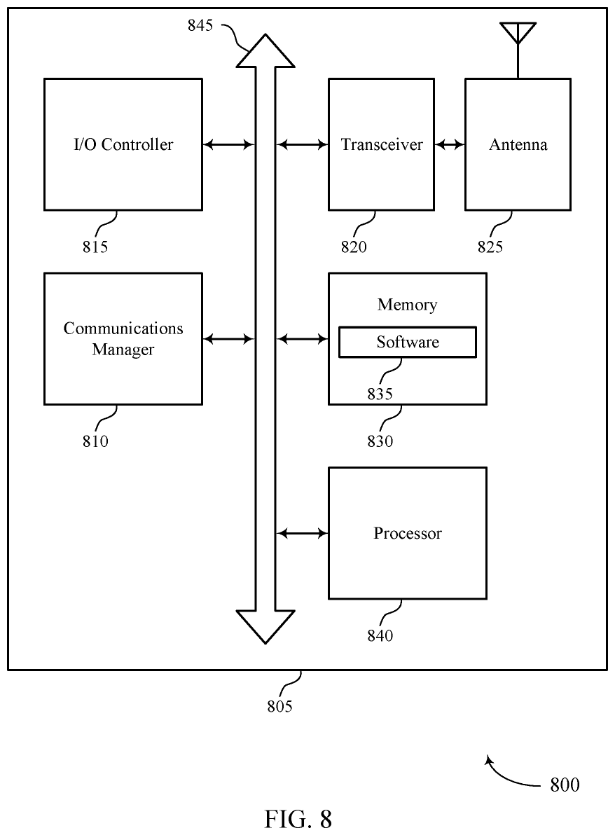

The receiver 510 may receive information such as packets, user data, or control information associated with various information channels (e.g., control channels, data channels, and information related to transmit optimizations for increased power savings on low power nodes, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may identify a message repetition configuration of the first device, receive an acknowledgement from the second device based on the transmitted indication, transmit an indication of a number of transmission repetitions to a second device, where the number of transmission repetitions is based on the message repetition configuration of the first device, and transmit an information payload to the second device based on the received acknowledgement, where the first device is configured to transmit the information payload based on the message repetition configuration of the first device. The communications manager 515 may also receive an indication of a number of transmission repetitions from a first device, where the number of transmission repetitions is based on the message repetition configuration of the first device, transmit an acknowledgement to the first device based on the received indication, receive an information payload from the first device based on the transmitted acknowledgement, where the first device is configured to transmit the information payload based on the message repetition configuration of the first device, and transmit a message including the information payload based on the indication of the number of transmission repetitions. The communications manager 515 may be an example of aspects of the communications manager 810 described herein.

The actions performed by the communications manager 515 as described herein may be implemented to realize one or more potential advantages. One implementation may allow a device (e.g., an LPN) to save power and increase battery life by avoiding having to transmit message repetitions (e.g., by leveraging help from a friend device). Additionally or alternatively, the device may further increase the extent in which the device may operate in a low power mode or sleep state (e.g., thus increasing battery life).

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

In some examples, the communications manager 515 may be implemented by a wireless modem chip or chipset, and the receiver 510 and transmitter 520 may be implemented by analog components (such as filters, amplifiers, or antennas) coupled with the wireless modem chip or chipset to enable the receipt and transmission of wireless signals. In some examples, the communications manager 515 may be coupled to the receiver 510 over a first interface to the transmitter 520 over a second interface. Additionally, or alternatively, the receiver 510 and the transmitter 520 may share some or all of the same analog components.

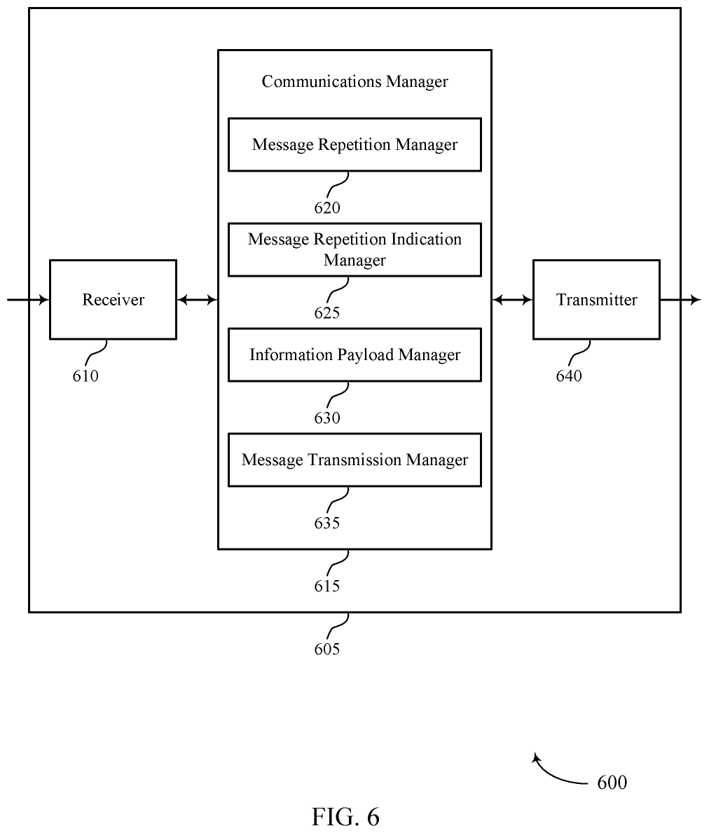

FIG. 6 shows a block diagram 600 of a device 605 that supports transmit optimizations for increased power savings on low power nodes in accordance with aspects of the present disclosure. The device 605 may be an example of aspects of a device 505 or a wireless device 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to transmit optimizations for increased power savings on low power nodes, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a message repetition manager 620, a message repetition indication manager 625, an information payload manager 630, and a message transmission manager 635. The communications manager 615 may be an example of aspects of the communications manager 810 described herein.

The message repetition manager 620 may identify a message repetition configuration of the first device and receive an acknowledgement from the second device based on the transmitted indication. The message repetition indication manager 625 may transmit an indication of a number of transmission repetitions to a second device, where the number of transmission repetitions is based on the message repetition configuration of the first device. The information payload manager 630 may transmit an information payload to the second device based on the received acknowledgement, where the first device is configured to transmit the information payload based on the message repetition configuration of the first device.

The message repetition indication manager 625 may receive an indication of a number of transmission repetitions from a first device, where the number of transmission repetitions is based on the message repetition configuration of the first device. The message repetition manager 620 may transmit an acknowledgement to the first device based on the received indication. The information payload manager 630 may receive an information payload from the first device based on the transmitted acknowledgement, where the first device is configured to transmit the information payload based on the message repetition configuration of the first device. The message transmission manager 635 may transmit a message including the information payload based on the indication of the number of transmission repetitions.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

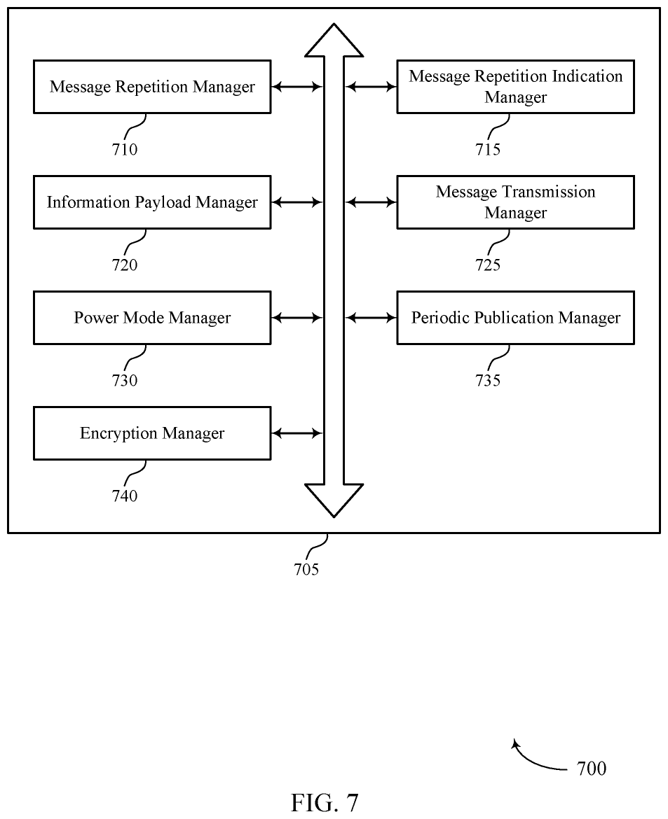

FIG. 7 shows a block diagram 700 of a communications manager 705 that supports transmit optimizations for increased power savings on low power nodes in accordance with aspects of the present disclosure. The communications manager 705 may be an example of aspects of a communications manager 515, a communications manager 615, or a communications manager 810 described herein. The communications manager 705 may include a message repetition manager 710, a message repetition indication manager 715, an information payload manager 720, a message transmission manager 725, a power mode manager 730, a periodic publication manager 735, and an encryption manager 740. Each of these modules may communicate, directly or indirectly, with one another (e.g., via one or more buses).

The message repetition manager 710 may identify a message repetition configuration of the first device. In some examples, the message repetition manager 710 may receive an acknowledgement from the second device based on the transmitted indication. In some examples, the message repetition manager 710 may transmit an acknowledgement to the first device based on the received indication. In some examples, the message repetition manager 710 may determine a sequence number after the transitioning, where the sequence number is calculated based on a transmission time of the transmitted first message, the number of transmission repetitions, a publish interval, or some combination thereof. In some examples, the message repetition manager 710 may identify a second message repetition configuration of the first device. In some examples, identifying a group publishing trigger, where the group publishing trigger includes a state change, a user event, or both.

In some examples, message repetition manager 710 may store the message repetition configuration of the first device, where the message repetition configuration of the first device includes the information payload and the number of transmission repetitions. In some examples, the message repetition manager 710 may identify the message repetition configuration of the first device based on the received indication that the information payload corresponds to the number of transmission repetitions, where the message repetition configuration of the first device is stored based on the identifying. In some examples, the message repetition manager 710 may identify a busy status of the second device. In some examples, the message repetition manager 710 may transmit an indication of the busy status to the first device based on the received information payload. In some examples, the message repetition manager 710 may receive a second information payload from the first device, where the first device is configured to transmit the second information payload based on the second message repetition configuration of the first device.

The message repetition indication manager 715 may transmit an indication of a number of transmission repetitions to a second device, where the number of transmission repetitions is based on the message repetition configuration of the first device. In some examples, the message repetition indication manager 715 may receive an indication of a number of transmission repetitions from a first device, where the number of transmission repetitions is based on the message repetition configuration of the first device. In some examples, the message repetition indication manager 715 may transmit, to the second device, an indication that the information payload corresponds to the number of transmission repetitions. In some examples, the message repetition indication manager 715 may transmit a second indication of a second number of transmission repetitions to the second device, where the second number of transmission repetitions is based on the second message repetition configuration of the first device.

In some examples, the message repetition indication manager 715 may transmit, to the second device, an indication that the second information payload corresponds to the second number of transmission repetitions. In some examples, the message repetition indication manager 715 may receive, from the first device, an indication that the information payload corresponds to the number of transmission repetitions. In some examples, the message repetition indication manager 715 may receive, from the first device, an indication that the information payload corresponds to the number of transmission repetitions. In some examples, the message repetition indication manager 715 may receive a second indication of a second number of transmission repetitions from the first device, where the second number of transmission repetitions is based on a second message repetition configuration of the first device. In some examples, the message repetition indication manager 715 may receive, from the first device, an indication that the second information payload corresponds to the second number of transmission repetitions. In some cases, the indication of the number of transmission repetitions further includes a retry timeout for unsegmented messages.

The information payload manager 720 may transmit an information payload to the second device based on the received acknowledgement, where the first device is configured to transmit the information payload based on the message repetition configuration of the first device. In some examples, the information payload manager 720 may receive an information payload from the first device based on the transmitted acknowledgement, where the first device is configured to transmit the information payload based on the message repetition configuration of the first device. In some examples, the information payload manager 720 may transmit a second information payload to the second device, where the first device is configured to transmit the second information payload based on the second message repetition configuration of the first device. In some examples, the information payload manager 720 may transmit a second message including a second information payload to the second device based on the identified group publishing trigger.

The message transmission manager 725 may transmit a message including the information payload based on the indication of the number of transmission repetitions. In some examples, the message transmission manager 725 may transmit a first message including the information payload. In some examples, the message transmission manager 725 may identify the first device has transmitted a first message including the information payload, where the message including the information payload is transmitted based on the identifying. In some examples, the message transmission manager 725 may transmit a second message including the second information payload based on the second indication of the second number of transmission repetitions.

The power mode manager 730 may enter a low power mode based on the transmitted first message. In some examples, the power mode manager 730 may transition from the low power mode to a high power mode.

The periodic publication manager 735 may start a periodic publication timer based on the transmitted first message, where the sequence number is determined based on the periodic publication timer, a publishing interval, and the transmission time of the transmitted first message. In some examples, transmitting the publishing interval with the information payload to the second device, where the information payload includes publishing information.

The encryption manager 740 may encrypt the indication of the number of transmission repetitions, where the indication of the number of transmission repetitions is transmitted to the second device based on the encrypting. In some examples, the encryption manager 740 may encrypt the information payload, where the information payload is transmitted to the second device based on the encrypting.

FIG. 8 shows a diagram of a system 800 including a device 805 that supports transmit optimizations for increased power savings on low power nodes in accordance with aspects of the present disclosure. The device 805 may be an example of or include the components of device 505, device 605, or a device as described herein. The device 805 may include components for bi-directional voice and data communications including components for transmitting and receiving communications, including a communications manager 810, an I/O controller 815, a transceiver 820, an antenna 825, memory 830, and a processor 840.

These components may be in electronic communication via one or more buses (e.g., bus 845). The communications manager 810 may identify a message repetition configuration of the first device, receive an acknowledgement from the second device based on the transmitted indication, transmit an indication of a number of transmission repetitions to a second device, where the number of transmission repetitions is based on the message repetition configuration of the first device, and transmit an information payload to the second device based on the received acknowledgement, where the first device is configured to transmit the information payload based on the message repetition configuration of the first device. The communications manager 810 may also receive an indication of a number of transmission repetitions from a first device, where the number of transmission repetitions is based on the message repetition configuration of the first device, transmit an acknowledgement to the first device based on the received indication, receive an information payload from the first device based on the transmitted acknowledgement, where the first device is configured to transmit the information payload based on the message repetition configuration of the first device, and transmit a message including the information payload based on the indication of the number of transmission repetitions. In some cases, the communications manager 810 may be implemented as a chip or chipset of a wireless modem. Additionally, or alternatively, the communications manager 810 may be implemented with one or more of the other components of the device 805 as a system on chip (SoC).

The actions performed by the communications manager 810 as described herein may be implemented to realize one or more potential advantages. One implementation may allow a device (e.g., an LPN) to save power and increase battery life by avoiding having to transmit message repetitions (e.g., by leveraging help from a friend device). Additionally or alternatively, the device may further increase the extent in which the device may operate in a low power mode or sleep state (e.g., thus increasing battery life). For example, the actions performed by the communications manager 810 may allow the communications manager 810 and/or processor 840 to reduce power (e.g., power off or reduce active circuitry) of other components of the device 805. For example, the actions performed by the communications manager 810 may allow the communications manager 810 and/or processor 840 to reduce power of the transceiver 820 as transmission repetitions are performed by a friend device, as ACKs are received by the friend device (e.g., on behalf of the device 805), etc.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code or software 835 including instructions that, when executed, cause the processor to perform various functions described herein. In some cases, the memory 830 may contain, among other things, a BIOS which may control basic hardware or software operation such as the interaction with peripheral components or devices.

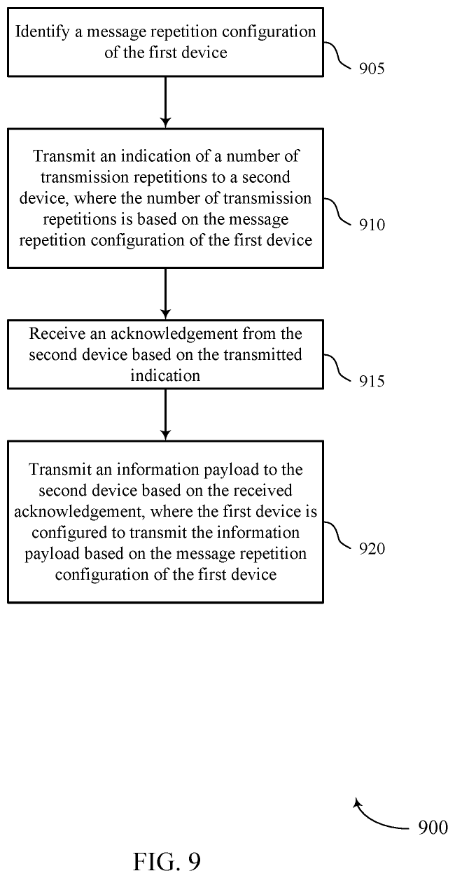

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting transmit optimizations for increased power savings on low power nodes). By implementing the techniques described herein, a processor 840 of a device (e.g., controlling the receiver 610, the transmitter 640, or the transceiver 820 as described with reference to FIG. 9) may efficiently power other components of the device, thus conserving power for the device.

The software 835 may include instructions to implement aspects of the present disclosure, including instructions to support wireless communications. The software 835 may be stored in a non-transitory computer-readable medium such as system memory or other type of memory. In some cases, the software 835 may not be directly executable by the processor 840 but may cause a computer (e.g., when compiled and executed) to perform functions described herein.

FIG. 9 shows a flowchart illustrating a method 900 that supports transmit optimizations for increased power savings on low power nodes in accordance with aspects of the present disclosure. The operations of method 900 may be implemented by a device or its components as described herein. For example, the operations of method 900 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 905, the device may identify a message repetition configuration of the first device. The operations of 905 may be performed according to the methods described herein. In some examples, aspects of the operations of 905 may be performed by a message repetition manager as described with reference to FIGS. 5 through 8.

At 910, the device may transmit an indication of a number of transmission repetitions to a second device, where the number of transmission repetitions is based on the message repetition configuration of the first device. The operations of 910 may be performed according to the methods described herein. In some examples, aspects of the operations of 910 may be performed by a message repetition indication manager as described with reference to FIGS. 5 through 8.

At 915, the device may receive an acknowledgement from the second device based on the transmitted indication. The operations of 915 may be performed according to the methods described herein. In some examples, aspects of the operations of 915 may be performed by a message repetition manager as described with reference to FIGS. 5 through 8.

At 920, the device may transmit an information payload to the second device based on the received acknowledgement, where the first device is configured to transmit the information payload based on the message repetition configuration of the first device. The operations of 920 may be performed according to the methods described herein. In some examples, aspects of the operations of 920 may be performed by an information payload manager as described with reference to FIGS. 5 through 8.

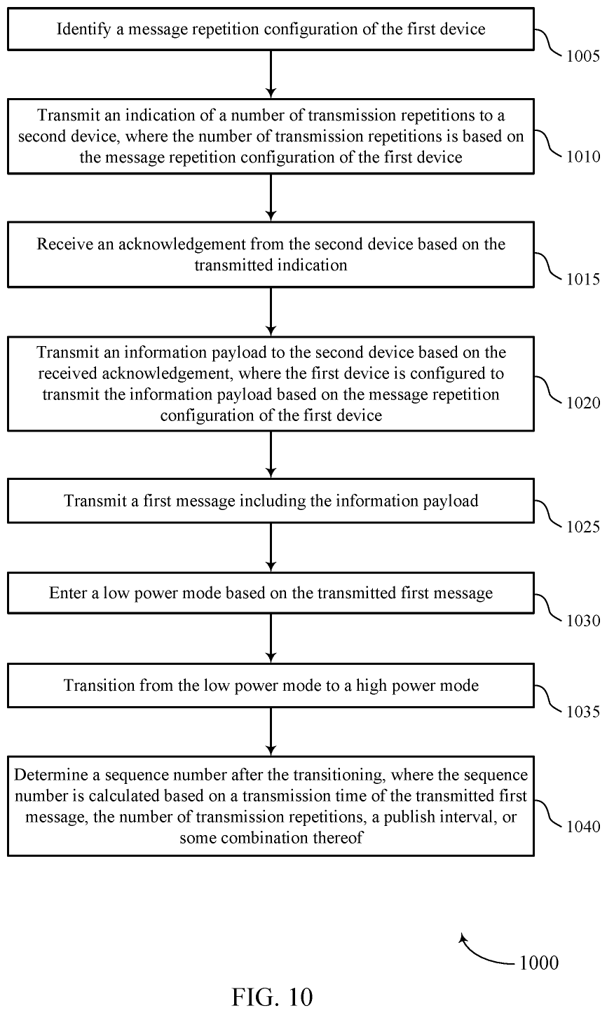

FIG. 10 shows a flowchart illustrating a method 1000 that supports transmit optimizations for increased power savings on low power nodes in accordance with aspects of the present disclosure. The operations of method 1000 may be implemented by a device or its components as described herein. For example, the operations of method 1000 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1005, the device may identify a message repetition configuration of the first device. The operations of 1005 may be performed according to the methods described herein. In some examples, aspects of the operations of 1005 may be performed by a message repetition manager as described with reference to FIGS. 5 through 8.

At 1010, the device may transmit an indication of a number of transmission repetitions to a second device, where the number of transmission repetitions is based on the message repetition configuration of the first device. The operations of 1010 may be performed according to the methods described herein. In some examples, aspects of the operations of 1010 may be performed by a message repetition indication manager as described with reference to FIGS. 5 through 8.

At 1015, the device may receive an acknowledgement from the second device based on the transmitted indication. The operations of 1015 may be performed according to the methods described herein. In some examples, aspects of the operations of 1015 may be performed by a message repetition manager as described with reference to FIGS. 5 through 8.

At 1020, the device may transmit an information payload to the second device based on the received acknowledgement, where the first device is configured to transmit the information payload based on the message repetition configuration of the first device. The operations of 1020 may be performed according to the methods described herein. In some examples, aspects of the operations of 1020 may be performed by an information payload manager as described with reference to FIGS. 5 through 8.

At 1025, the device may transmit a first message including the information payload. The operations of 1025 may be performed according to the methods described herein. In some examples, aspects of the operations of 1025 may be performed by a message transmission manager as described with reference to FIGS. 5 through 8.

At 1030, the device may enter a low power mode based on the transmitted first message. The operations of 1030 may be performed according to the methods described herein. In some examples, aspects of the operations of 1030 may be performed by a power mode manager as described with reference to FIGS. 5 through 8.

At 1035, the device may transition from the low power mode to a high power mode. The operations of 1035 may be performed according to the methods described herein. In some examples, aspects of the operations of 1035 may be performed by a power mode manager as described with reference to FIGS. 5 through 8.

At 1040, the device may determine a sequence number after the transitioning, where the sequence number is calculated based on a transmission time of the transmitted first message, the number of transmission repetitions, a publish interval, or some combination thereof. The operations of 1040 may be performed according to the methods described herein. In some examples, aspects of the operations of 1040 may be performed by a message repetition manager as described with reference to FIGS. 5 through 8.

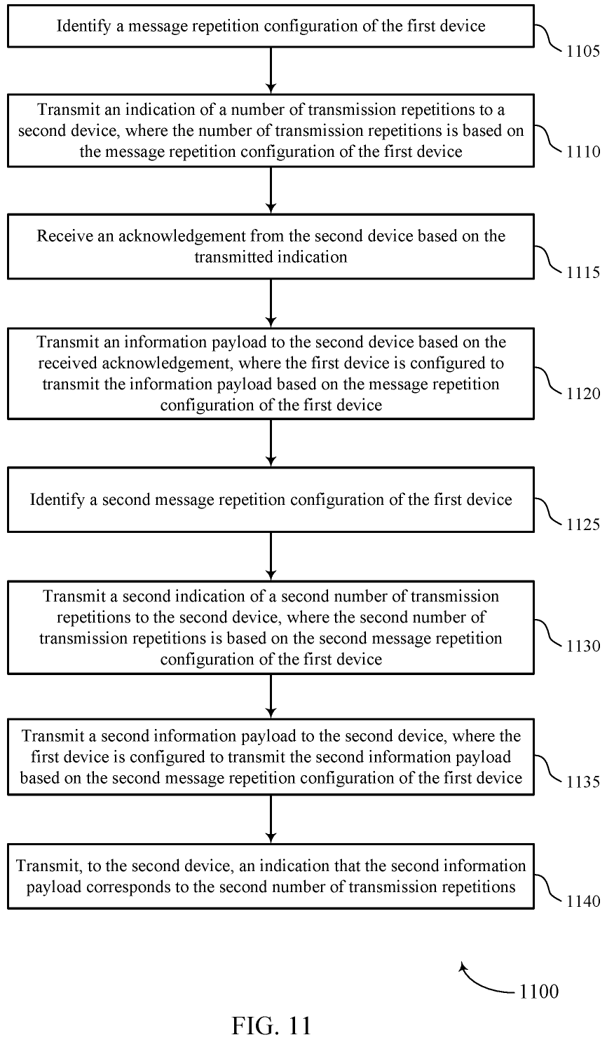

FIG. 11 shows a flowchart illustrating a method 1100 that supports transmit optimizations for increased power savings on low power nodes in accordance with aspects of the present disclosure. The operations of method 1100 may be implemented by a device or its components as described herein. For example, the operations of method 1100 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1105, the device may identify a message repetition configuration of the first device. The operations of 1105 may be performed according to the methods described herein. In some examples, aspects of the operations of 1105 may be performed by a message repetition manager as described with reference to FIGS. 5 through 8.

At 1110, the device may transmit an indication of a number of transmission repetitions to a second device, where the number of transmission repetitions is based on the message repetition configuration of the first device. The operations of 1110 may be performed according to the methods described herein. In some examples, aspects of the operations of 1110 may be performed by a message repetition indication manager as described with reference to FIGS. 5 through 8.

At 1115, the device may receive an acknowledgement from the second device based on the transmitted indication. The operations of 1115 may be performed according to the methods described herein. In some examples, aspects of the operations of 1115 may be performed by a message repetition manager as described with reference to FIGS. 5 through 8.

At 1120, the device may transmit an information payload to the second device based on the received acknowledgement, where the first device is configured to transmit the information payload based on the message repetition configuration of the first device. The operations of 1120 may be performed according to the methods described herein. In some examples, aspects of the operations of 1120 may be performed by an information payload manager as described with reference to FIGS. 5 through 8.

At 1125, the device may identify a second message repetition configuration of the first device. The operations of 1125 may be performed according to the methods described herein. In some examples, aspects of the operations of 1125 may be performed by a message repetition manager as described with reference to FIGS. 5 through 8.

At 1130, the device may transmit a second indication of a second number of transmission repetitions to the second device, where the second number of transmission repetitions is based on the second message repetition configuration of the first device. The operations of 1130 may be performed according to the methods described herein. In some examples, aspects of the operations of 1130 may be performed by a message repetition indication manager as described with reference to FIGS. 5 through 8.

At 1135, the device may transmit a second information payload to the second device, where the first device is configured to transmit the second information payload based on the second message repetition configuration of the first device. The operations of 1135 may be performed according to the methods described herein. In some examples, aspects of the operations of 1135 may be performed by an information payload manager as described with reference to FIGS. 5 through 8.

At 1140, the device may transmit, to the second device, an indication that the second information payload corresponds to the second number of transmission repetitions. The operations of 1140 may be performed according to the methods described herein. In some examples, aspects of the operations of 1140 may be performed by a message repetition indication manager as described with reference to FIGS. 5 through 8.

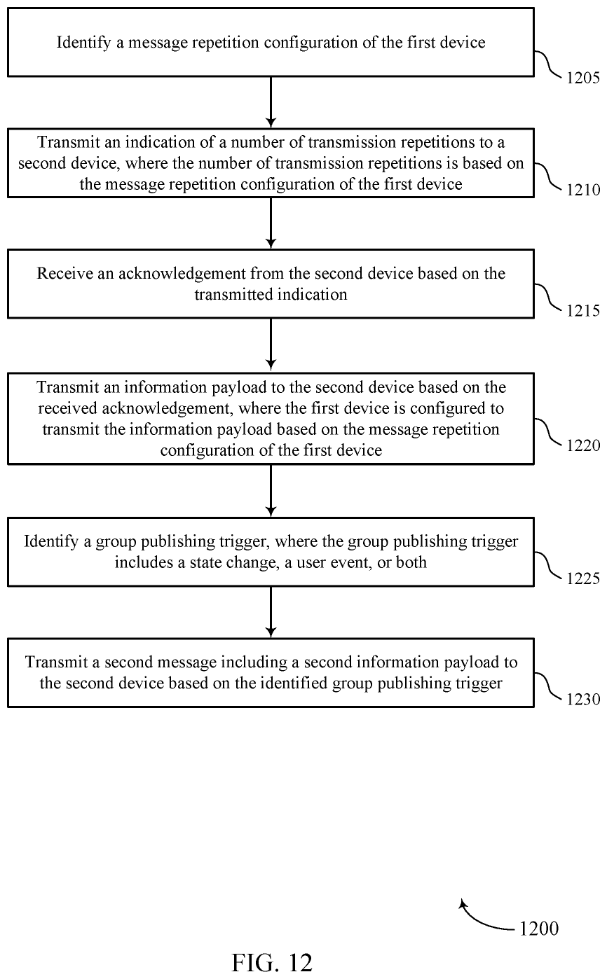

FIG. 12 shows a flowchart illustrating a method 1200 that supports transmit optimizations for increased power savings on low power nodes in accordance with aspects of the present disclosure. The operations of method 1200 may be implemented by a device or its components as described herein. For example, the operations of method 1200 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1205, the device may identify a message repetition configuration of the first device. The operations of 1205 may be performed according to the methods described herein. In some examples, aspects of the operations of 1205 may be performed by a message repetition manager as described with reference to FIGS. 5 through 8.

At 1210, the device may transmit an indication of a number of transmission repetitions to a second device, where the number of transmission repetitions is based on the message repetition configuration of the first device. The operations of 1210 may be performed according to the methods described herein. In some examples, aspects of the operations of 1210 may be performed by a message repetition indication manager as described with reference to FIGS. 5 through 8.

At 1215, the device may receive an acknowledgement from the second device based on the transmitted indication. The operations of 1215 may be performed according to the methods described herein. In some examples, aspects of the operations of 1215 may be performed by a message repetition manager as described with reference to FIGS. 5 through 8.

At 1220, the device may transmit an information payload to the second device based on the received acknowledgement, where the first device is configured to transmit the information payload based on the message repetition configuration of the first device. The operations of 1220 may be performed according to the methods described herein. In some examples, aspects of the operations of 1220 may be performed by an information payload manager as described with reference to FIGS. 5 through 8.

At 1225, the device may identify a group publishing trigger, where the group publishing trigger includes a state change, a user event, or both. The operations of 1225 may be performed according to the methods described herein. In some examples, aspects of the operations of 1225 may be performed by a message repetition manager as described with reference to FIGS. 5 through 8.

At 1230, the device may transmit a second message including a second information payload to the second device based on the identified group publishing trigger. The operations of 1230 may be performed according to the methods described herein. In some examples, aspects of the operations of 1230 may be performed by an information payload manager as described with reference to FIGS. 5 through 8.

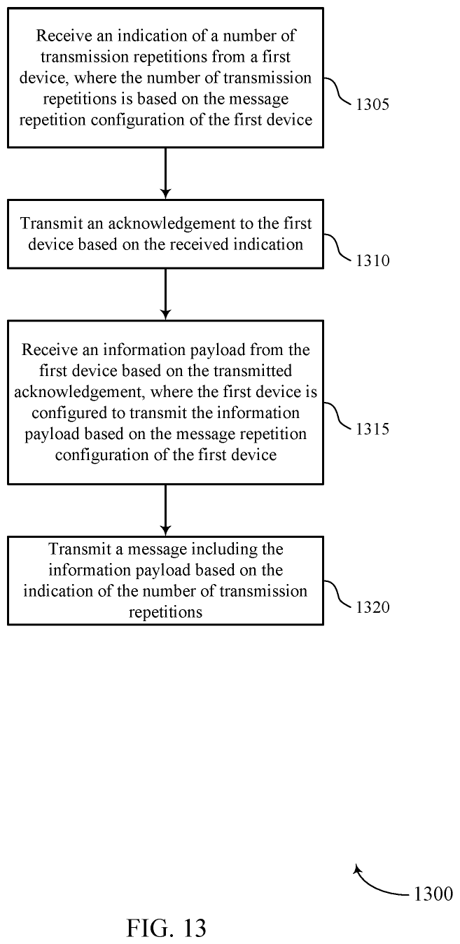

FIG. 13 shows a flowchart illustrating a method 1300 that supports transmit optimizations for increased power savings on low power nodes in accordance with aspects of the present disclosure. The operations of method 1300 may be implemented by a device or its components as described herein. For example, the operations of method 1300 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1305, the device may receive an indication of a number of transmission repetitions from a first device, where the number of transmission repetitions is based on the message repetition configuration of the first device. The operations of 1305 may be performed according to the methods described herein. In some examples, aspects of the operations of 1305 may be performed by a message repetition indication manager as described with reference to FIGS. 5 through 8.

At 1310, the device may transmit an acknowledgement to the first device based on the received indication. The operations of 1310 may be performed according to the methods described herein. In some examples, aspects of the operations of 1310 may be performed by a message repetition manager as described with reference to FIGS. 5 through 8.

At 1315, the device may receive an information payload from the first device based on the transmitted acknowledgement, where the first device is configured to transmit the information payload based on the message repetition configuration of the first device. The operations of 1315 may be performed according to the methods described herein. In some examples, aspects of the operations of 1315 may be performed by an information payload manager as described with reference to FIGS. 5 through 8.

At 1320, the device may transmit a message including the information payload based on the indication of the number of transmission repetitions. The operations of 1320 may be performed according to the methods described herein. In some examples, aspects of the operations of 1320 may be performed by a message transmission manager as described with reference to FIGS. 5 through 8.

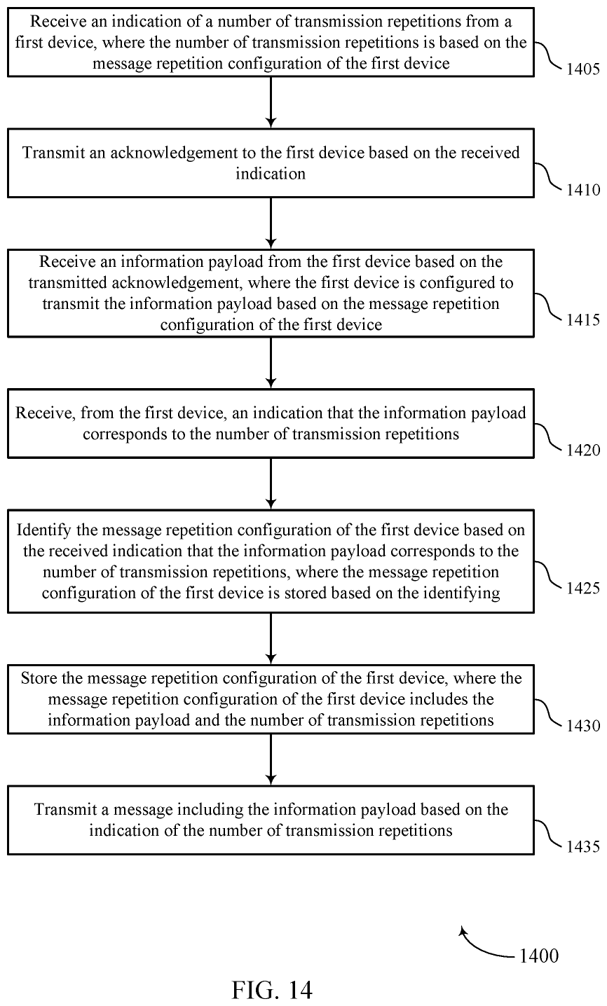

FIG. 14 shows a flowchart illustrating a method 1400 that supports transmit optimizations for increased power savings on low power nodes in accordance with aspects of the present disclosure. The operations of method 1400 may be implemented by a device or its components as described herein. For example, the operations of method 1400 may be performed by a communications manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1405, the device may receive an indication of a number of transmission repetitions from a first device, where the number of transmission repetitions is based on the message repetition configuration of the first device. The operations of 1405 may be performed according to the methods described herein. In some examples, aspects of the operations of 1405 may be performed by a message repetition indication manager as described with reference to FIGS. 5 through 8.

At 1410, the device may transmit an acknowledgement to the first device based on the received indication. The operations of 1410 may be performed according to the methods described herein. In some examples, aspects of the operations of 1410 may be performed by a message repetition manager as described with reference to FIGS. 5 through 8.

At 1415, the device may receive an information payload from the first device based on the transmitted acknowledgement, where the first device is configured to transmit the information payload based on the message repetition configuration of the first device. The operations of 1415 may be performed according to the methods described herein. In some examples, aspects of the operations of 1415 may be performed by an information payload manager as described with reference to FIGS. 5 through 8.

At 1420, the device may receive, from the first device, an indication that the information payload corresponds to the number of transmission repetitions. The operations of 1420 may be performed according to the methods described herein. In some examples, aspects of the operations of 1420 may be performed by a message repetition indication manager as described with reference to FIGS. 5 through 8.

At 1425, the device may identify the message repetition configuration of the first device based on the received indication that the information payload corresponds to the number of transmission repetitions, where the message repetition configuration of the first device is stored based on the identifying. The operations of 1425 may be performed according to the methods described herein. In some examples, aspects of the operations of 1425 may be performed by a message repetition manager as described with reference to FIGS. 5 through 8.

At 1430, the device may store the message repetition configuration of the first device, where the message repetition configuration of the first device includes the information payload and the number of transmission repetitions. The operations of 1430 may be performed according to the methods described herein. In some examples, aspects of the operations of 1430 may be performed by a message repetition manager as described with reference to FIGS. 5 through 8.

At 1435, the device may transmit a message including the information payload based on the indication of the number of transmission repetitions. The operations of 1435 may be performed according to the methods described herein. In some examples, aspects of the operations of 1435 may be performed by a message transmission manager as described with reference to FIGS. 5 through 8.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, system 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a first device, comprising:
identifying a message repetition configuration of the first device;
transmitting an indication of a number of transmission repetitions to a second device, wherein the number of transmission repetitions is based at least in part on the message repetition configuration of the first device;
receiving an acknowledgement from the second device based at least in part on the transmitted indication; and
transmitting an information payload to the second device based at least in part on the received acknowledgement, wherein the first device is configured to transmit the information payload based at least in part on the message repetition configuration of the first device.

2. The method of claim 1, further comprising:
transmitting a first message comprising the information payload; and
entering a low power mode based at least in part on the transmitted first message.

3. The method of claim 2, further comprising:
transitioning from the low power mode to a high power mode; and
determining a sequence number after the transitioning, wherein the sequence number is calculated based at least in part on a transmission time of the transmitted first message, the number of transmission repetitions, a publish interval, or some combination thereof.

4. The method of claim 3, further comprising:
starting a periodic publication timer based at least in part on the transmitted first message, wherein the sequence number is determined based at least in part on the periodic publication timer, a publishing interval, and the transmission time of the transmitted first message.

5. The method of claim 4, further comprising:
transmitting the publishing interval with the information payload to the second device, wherein the information payload comprises publishing information.

6. The method of claim 1, further comprising:
transmitting, to the second device, an indication that the information payload corresponds to the number of transmission repetitions.

7. The method of claim 1, further comprising:
identifying a second message repetition configuration of the first device;
transmitting a second indication of a second number of transmission repetitions to the second device, wherein the second number of transmission repetitions is based at least in part on the second message repetition configuration of the first device;
transmitting a second information payload to the second device, wherein the first device is configured to transmit the second information payload based at least in part on the second message repetition configuration of the first device; and
transmitting, to the second device, an indication that the second information payload corresponds to the second number of transmission repetitions.

8. The method of claim 1, further comprising:
identifying a group publishing trigger, wherein the group publishing trigger comprises a state change, a user event, or both; and
transmitting a second message comprising a second information payload to the second device based at least in part on the identified group publishing trigger.

9. The method of claim 1, further comprising:
encrypting the indication of the number of transmission repetitions, wherein the indication of the number of transmission repetitions is transmitted to the second device based at least in part on the encrypting; and
encrypting the information payload, wherein the information payload is transmitted to the second device based at least in part on the encrypting.

10. The method of claim 1, wherein the indication of the number of transmission repetitions further comprises a retry timeout for unsegmented messages.

11. A method for wireless communications at a second device, comprising:
receiving an indication of a number of transmission repetitions from a first device, wherein the number of transmission repetitions is based at least in part on a message repetition configuration of the first device;
transmitting an acknowledgement to the first device based at least in part on the received indication;
receiving an information payload from the first device based at least in part on the transmitted acknowledgement, wherein the first device is configured to transmit the information payload based at least in part on the message repetition configuration of the first device; and
transmitting a message comprising the information payload based at least in part on the indication of the number of transmission repetitions.

12. The method of claim 11, further comprising:
storing the message repetition configuration of the first device, wherein the message repetition configuration of the first device comprises the information payload and the number of transmission repetitions.

13. The method of claim 12, further comprising:
receiving, from the first device, an indication that the information payload corresponds to the number of transmission repetitions; and
identifying the message repetition configuration of the first device based at least in part on the received indication that the information payload corresponds to the number of transmission repetitions, wherein the message repetition configuration of the first device is stored based at least in part on the identifying.

14. The method of claim 11, further comprising:
identifying a busy status of the second device; and
transmitting an indication of the busy status to the first device based at least in part on the received information payload.

15. The method of claim 11, further comprising:
receiving, from the first device, an indication that the information payload corresponds to the number of transmission repetitions.

16. The method of claim 11, further comprising:
identifying the first device has transmitted a first message comprising the information payload, wherein the message comprising the information payload is transmitted based at least in part on the identifying.

17. The method of claim 11, further comprising:
receiving a second indication of a second number of transmission repetitions from the first device, wherein the second number of transmission repetitions is based at least in part on a second message repetition configuration of the first device;
receiving a second information payload from the first device, wherein the first device is configured to transmit the second information payload based at least in part on the second message repetition configuration of the first device;
receiving, from the first device, an indication that the second information payload corresponds to the second number of transmission repetitions; and
transmitting a second message comprising the second information payload based at least in part on the second indication of the second number of transmission repetitions.

18. An apparatus for wireless communications at a first device, comprising:
a processor,
memory in electronic communication with the processor; and
instructions stored in the memory and executable by the processor to cause the apparatus to:
identify a message repetition configuration of the first device;
transmit an indication of a number of transmission repetitions to a second device, wherein the number of transmission repetitions is based at least in part on the message repetition configuration of the first device;
receive an acknowledgement from the second device based at least in part on the transmitted indication; and
transmit an information payload to the second device based at least in part on the received acknowledgement, wherein the first device is configured to transmit the information payload based at least in part on the message repetition configuration of the first device.

19. The apparatus of claim 18, wherein the instructions are further executable by the processor to cause the apparatus to:
transmit a first message comprising the information payload; and
enter a low power mode based at least in part on the transmitted first message.

20. The apparatus of claim 19, wherein the instructions are further executable by the processor to cause the apparatus to:
transition from the low power mode to a high power mode; and
determine a sequence number after the transitioning, wherein the sequence number is calculated based at least in part on a transmission time of the transmitted first message, the number of transmission repetitions, a publish interval, or some combination thereof.
